(19) United States
(12) Patent Application Publication
(10) Pub. No.: US 2001/0027467 A1
(43) Pub. Date: Oct. 4, 2001

(54) Massively distributed database system and associated method

(76) Inventors: David P. Anderson, Berkeley, CA (US); Edward A. Hubbard, Round Rock, TX (US)

Correspondence Address: Brian W. Peterman, O'KEEFE, EGAN & PETERMAN, Building C, Suite 200, 1101 Capital of Texas Highway South, Austin, TX, 78746, US

(21) Appl. No.: 09/872,251

(22) Filed: May 31, 2001

Related U.S. Application Data
(63) Continuation-in-part of application No. 09/538,543, filed on Mar. 30, 2000.
(63) Continuation-in-part of application No. 09/539,448, filed on Mar. 30, 2000.
(63) Continuation-in-part of application No. 09/603,740, filed on Jun. 23, 2000.
(63) Continuation-in-part of application No. 09/648,832, filed on Aug. 25, 2000.

(51) Int. Cl. G06F 15/16; G06F 15/173

(52) U.S. Cl. 709/201; 709/224; 709/226

(57) ABSTRACT

A massively distributed database system and associated method are disclosed that utilize a multitude of widely distributed devices and advantageously provides increased storage capacity, availability, and throughput, and decreased latency, compared to existing distributed database architectures.

This application is a continuation-in-part application of the following co-pending applications: application Ser. No. 09/538,543 entitled “DISTRIBUTED PARALLEL PROCESSING SYSTEM HAVING CAPABILITY-BASED INCENTIVES AND ASSOCIATED METHOD,” application Ser. No. 09/539,448 entitled “CAPABILITY-BASED DISTRIBUTED PARALLEL PROCESSING SYSTEM AND ASSOCIATED METHOD,” each of which was filed on Mar. 30, 2000. This application is also a continuation-in-part application of the following co-pending application: application Ser. No. 09/603,740 entitled “METHOD OF MANAGING WORKLOADS AND ASSOCIATED DISTRIBUTED PROCESSING SYSTEM,” which was filed on Jun. 23, 2000. This application is also a continuation-in-part application of the following co-pending application: application Ser. No. 09/648,832 entitled “SECURITY ARCHITECTURE FOR DISTRIBUTED PROCESSING SYSTEMS AND ASSOCIATED METHOD,” which was filed on Aug. 25, 2000.

### TECHNICAL FIELD OF THE INVENTION

This invention relates to database architectures and to distributing data storage and processing among distributed devices. More particularly, the present invention relates to techniques and related methods for managing, facilitating and implementing database operations in a distributed environment.

### BACKGROUND

Existing distributed database architectures attempt to utilize a relatively small number of geographically local computers to handle database functions. For example, a company may utilize a plurality of server computers linked together by a local area network (LAN) to share processing tasks for the company's database needs. Such typical distributed database architectures, however, are limited in their scale and processing ability by the constraints of the LAN and the number of available computers.

### SUMMARY OF THE INVENTION

The present invention provides a massively distributed database system and associated method that utilizes a multitude of widely distributed devices and advantageously provides increased data storage capacity and throughput, and decreased latency and cost, compared to existing distributed database architectures.

In one embodiment, the present invention is a distributed database system including a plurality of distributed worker systems, the worker systems acting as data servers, at least one coordinator system configured to communicate with the plurality of worker systems through a network, and a database administered by a first entity utilizing the coordinator system and the plurality of worker systems, wherein at least a portion of the worker systems are owned and operated by at least one second entity that is different from the first entity. In more detailed respects, there may be over a thousand worker systems, and the coordinator system maintains information about the current performance and availability of each of the worker systems. In addition, the operators of each worker computer may control parameters of data server usage for the worker computer, and the controlling parameters comprise an amount of network bandwidth utilized, disk space usage, or hours of usage. Still further, data and indexing information for the database may be organized in a multi-level hierarchy, and distribution of data, index information, and user requests may be dynamically modified in response to an actual load to optimize performance of the database system.

In another embodiment, the present invention is a distributed database system including at least one thousand distributed worker systems acting as data servers, at least one coordinator system configured to communicate with the worker systems through a network, and a database administered by utilizing the at least one coordinator system and the plurality of worker systems. In more detailed respects, the database may be administered by an entity, and the worker systems may be owned and operated by the same entity.

In still another embodiment, the present invention is a distributed processing system providing database operations including a plurality of client systems running a client agent program that has a database module, at least one server system configured to communicate with the plurality of client systems through a network to coordinate database workloads processed by the database modules, and a capabilities database coupled to the server system, the capabilities database comprising data concerning processing capabilities for the client systems, wherein the server system utilizes the capabilities database to schedule database workloads for the database modules. In more detailed respects, the system may include a load database comprising load data about each client system, where the load data identifying current database workload processing utilization for the client system. In addition, the server system may utilize the current load data to balance database workloads among the client systems. Furthermore, the system may include an incentives database coupled to the server system, the incentives database comprising incentive data for each of the client systems, where the incentive data acting to encourage each client system to be utilized for objectives of the distributed processing system.

In yet another embodiment, the present invention is a method of operating a distributed database system including coupling a coordinator system to a network such that the coordinator system is configured to communicate with a plurality of worker systems through a network and the worker systems are configured to act as data servers for a database system, and administering the database system through a first entity that does not own or operate all of the worker systems. In more detailed respects, the method may also include allowing operators of each worker system to control parameters of data server usage for the worker system, and the controlling parameters may include an amount of network bandwidth utilized or hours of usage. Still further, the method may include organizing data and indexing information for the database in a multi-level hierarchy, and dynamically modifying distribution of data, index information, and user requests in response to an actual load to optimize performance of the database system.

In still another embodiment, the present invention is a method of operating a distributed processing system to provide a distributed database system including coupling at least one coordinator system to a network such that the coordinator system is configured to communicate with a plurality of worker systems through a network and the worker systems are configured to act as data servers for a database system where the number of worker systems is at least one thousand, and administering the database system utilizing the coordinator system and the worker systems. In more detailed respects, the database is administered by an entity and the worker systems are operated by the same entity.

In a further embodiment, the present invention is a method of operating a distributed processing system to provide a distributed database system including coupling a server system to a network with the server system being configured to communicate with a plurality of client systems through a network and with the client systems configured to run a client agent program that is running a database module that allows the client systems to function as data servers for a distributed database system, storing in a capabilities database data concerning processing capabilities for the client systems, and managing the distributed database system with the server t-S system utilizing the capabilities database to schedule database workloads for the database modules. In more detailed respects, the method may include storing in a load database load data about each client system where the load data identifying current workload processing utilization for the client system and utilizing the current load data to balance database workloads among the client systems. Still further, the method may include storing in an incentives database incentive data for each of the client systems where the incentive data acting to encourage each client system to be utilized for objectives of the distributed processing system.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a block diagram for a distributed processing system having client capability and incentive features, according to the present invention.

FIG. 1B is a block diagram for information flow among customer systems, server systems and client systems, according to the present invention.

FIG. 2 is a block diagram for a massively distributed database (MDDB) system, according to the present invention.

FIG. 3A is a block diagram for a coordinator computer for the MDDB system, according to the present invention.

FIG. 3B is a block diagram for a worker computer for the MDDB system, according to the present invention.

FIG. 3C is a block diagram for a user computer for the MDDB system, according to the present invention.

FIG. 4 is a block diagram for a database structure for the MDDB system, according to the present invention.

### DETAILED DESCRIPTION OF THE INVENTION

The present invention contemplates an architecture for a massively distributed database (MDDB) system that operates in a distributed computing environment. This novel architecture takes advantage of a multitude of widely distributed computing devices and their capabilities, particularly their under-utilized capabilities, to implement and operate a database system. As discussed in detail below, the MDDB system can be advantageously managed by coordinator computer systems that are not commonly owned with the worker computer systems that provide the work processing for the database operations. These worker computer systems may also be part of a distributed computing system for which the database operations can be just a portion of the overall operations.

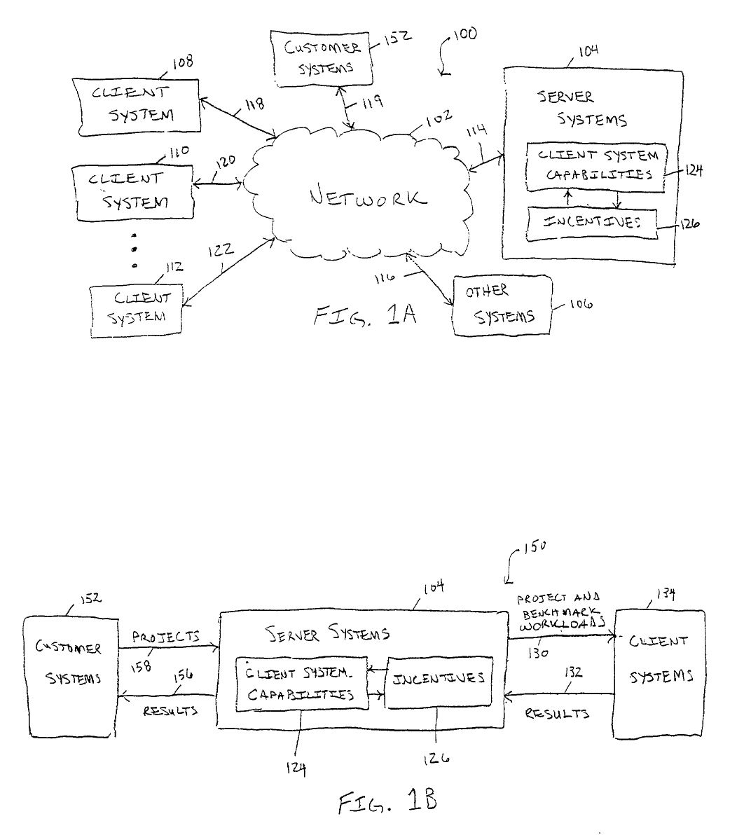

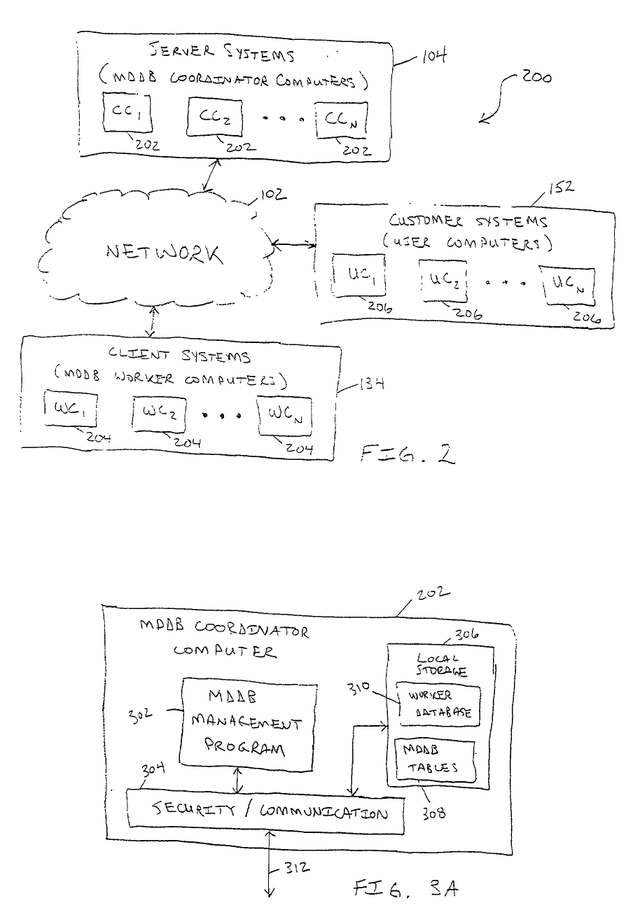

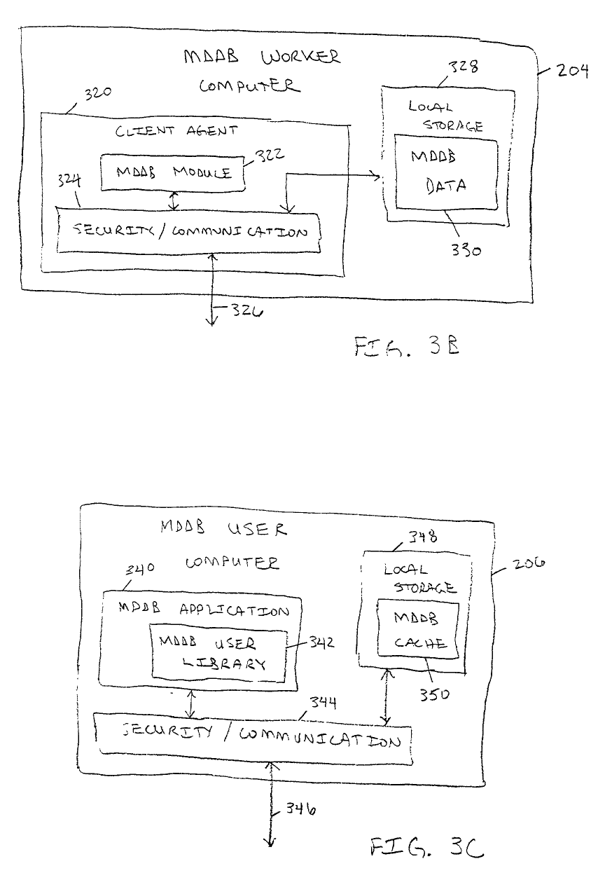

Example embodiments for the massively distributed database (MDDB) system of the present invention are described below with respect to FIGS. 2, 3A-C and 4. First, however, with respect to FIGS. 1A and 1B, an example distributed computing environment for the MDDB system is described. Such distributed computing environments utilizing network-connected computing devices are described in more detail in co-pending applications: application Ser. No. 09/538,543 entitled “DISTRIBUTED PARALLEL PROCESSING SYSTEM HAVING CAPABILITY-BASED INCENTIVES AND ASSOCIATED METHOD,” application Ser. No. 09/539,448 entitled “CAPABILITY-BASED DISTRIBUTED PARALLEL PROCESSING SYSTEM AND ASSOCIATED METHOD,” application Ser. No. 09/602,740 entitled “METHOD OF MANAGING WORKLOADS AND ASSOCIATED DISTRIBUTED PROCESSING SYSTEM,” and application Ser. No. 09/648,832 entitled “SECURITY ARCHITECTURE FOR —DISTRIBUTED PROCESSING SYSTEMS AND ASSOCIATED METHOD,” each of which is each hereby incorporated by reference in its entirety.

As described more fully therein, distributed processing systems according to the present invention may identify the capabilities of distributed devices connected together through a wide variety of communication systems and networks and then utilize these capabilities to accomplish database objectives of the MDDB system. For example, distributed devices connected to each other through the Internet, an intranet network, a wireless network, home networks, or any other network may provide any of a number of useful capabilities to third parties once their respective capabilities are identified, organized, and managed for a desired task. These distributed devices may be connected personal computer systems (PCs), internet appliances, notebook computers, servers, storage devices, network attached storage (NAS) devices, wireless devices, hand-held devices, or any other computing device that has useful capabilities and is connected to a network in any manner. The present invention further contemplates providing an incentive, which may be based in part upon capabilities of the distributed devices, to encourage users and owners of the distributed devices to allow the capabilities of the distributed devices to be utilized in the distributed parallel processing system of the present invention.

The number of usable distributed devices contemplated by the present invention is preferably very large. Unlike a small local network environment, for example, which may include less than 100 interconnected computers systems, the present invention preferably utilizes a multitude of widely distributed devices to provide a massively distributed processing system. With respect to the present invention, a multitude of distributed devices refers to greater than 1,000 different distributed devices. With respect to the present invention, widely distributed devices refers to a group of interconnected devices of which at least two are physically located at least 100 miles apart. With respect to the present invention, a massively distributed processing system is one that utilizes a multitude of widely distributed devices. The Internet is an example of a interconnected system that includes a multitude of widely distributed devices. An intranet system at a large corporation is an example of an interconnected system that includes multitude of distributed devices, and if multiple corporate sites are involved, may include a multitude of widely distributed devices. A distributed processing system according to the present invention that utilizes such a multitude of widely distributed devices, as are available on the Internet or in a large corporate intranet, is a massively distributed processing system according to the present invention.

Looking now to FIG. 1A, block diagram is depicted for a distributed parallel processing system 100 according to the present invention. The network 102 is shown having a cloud outline to indicate the unlimited and widely varying nature of the network and of attached client types. For example, the network 102 may be the Internet, an internal company intranet, a local area network (LAN), a wide area network (WAN), a wireless network, a home network or any other system that connects together multiple systems and devices. In addition, network 102 may include any of these types of connectivity systems by themselves or in combination, for example, computer systems on a company intranet connected to computer systems on the Internet.

FIG. 1A also shows client systems 108, 110 . . . 112 connected to the network 102 through communication links 118, 120 . . . 122, respectively. In addition, server systems 104, other systems 106, and customer systems 152 are connected to the network 102 through communication links 114, 116 and 119, respectively. The client system capabilities block 124 is a subset of the server systems 104 and represents a determination of the capabilities of the client systems 108, 110 . . . 112. These client system capabilities, which may be stored in a capabilities database as part of the server systems 104, may be used by the server systems 104 to schedule project workloads, such as a database workload as further discussed below, for the client systems 108, 110 . . . 112. The incentives block 126 is also a subset of the server systems 104 and represents an incentive provided to the users or owners of the clients systems 108, 110 . . . 112 for allowing capabilities of the clients systems 108, 110 . . . 112 to be utilized by the distributed processing system 100. These client system incentives, which may be stored in an incentives database as part of the server systems 104, may be used by the server systems 104 to encourage client systems to be utilized for objectives of the distributed processing system.

It is noted that the client systems 108, 110 and 112 represent any number of systems and/or devices that may be identified, organized and utilized by the server systems 104 to accomplish a desired task, for example, personal computer systems (PCs), internet appliances, notebook computers, servers, storage devices, network attached storage (NAS) devices, wireless devices, hand-held devices, or any other computing device that has useful capabilities and is connected to a network in any manner. The server systems 104 represent any number of processing systems that provide the function of identifying, organizing and utilizing the client systems to achieve the desired tasks.

The incentives provided by the incentives block 126 may be any desired incentive. For example, the incentive may be a sweepstakes in which entries are given to client systems 108, 110 . . . 112 that are signed up to be utilized by the distributed processing system 100. Other example incentives are reward systems, such as airline frequent-flyer miles, purchase credits and vouchers, payments of money, monetary prizes, property prizes, free trips, time-share rentals, cruises, connectivity services, free or reduced cost Internet access, domain name hosting, mail accounts, participation in significant research projects, achievement of personal goals, or any other desired incentive or reward.

As indicated above, any number of other systems may also be connected to the network 102. The element 106, therefore, represents any number of a variety of other systems that may be connected to the network 102. The other systems 106 may include ISPs, web servers, university computer systems, and any other distributed device connected to the network 102, for example, personal computer systems (PCs), internet appliances, notebook computers, servers, storage devices, network attached storage (NAS) devices, wireless devices, hand-held devices, or any other connected computing device that has useful capabilities and is connected to a network in any manner. The customer systems 152 represents customers that have projects for the distributed processing system, as further described with respect to FIG. 1B. The customer systems 152 connect to the network 102 through the communication link 119.

It is noted that the communication links 114, 116, 118, 119, 120 and 122 may allow for communication to occur, if desired, between any of the systems connected to the network 102. For example, client systems 108, 110 . . . 112 may communicate directly with each other in peer-to-peer type communications. It is further noted that the communication links 114, 116, 118, 119, 120 and 122 may be any desired technique for connecting into any portion of the network 102, such as, Ethernet connections, wireless connections, ISDN connections, DSL connections, modem dial-up connections, cable modem connections, fiber optic connections, direct T1 or T3 connections, routers, portal computers, as well as any other network or communication connection. It is also noted that there are any number of possible configurations for the connections for network 102, according to the present invention. The client system 108 may be, for example, an individual personal computer located in someone's home and may be connected to the Internet through an Internet Service Provider (ISP). Client system 108 may also be a personal computer located on an employee's desk at a company that is connected to an intranet through a network router and then connected to the Internet through a second router or portal computer. Client system 108 may further be personal computers connected to a company's intranet, and the server systems 104 may also be connected to that same intranet. In short, a wide variety of network environments are contemplated by the present invention on which a large number of potential client systems are connected.

FIG. 1B is a block diagram for an information flow 150 among customer systems 152, server systems 104 and client system 134, for an example distributed processing system environment. The server systems 104, as discussed above, may include any number of different subsystems or components, as desired, including client system capabilities block 124 and incentives block 126. The server systems 104 send project and benchmark workloads 130 to client systems 134. A benchmark workload refers to a standard workload that may be used to determine the relative capabilities of the client systems 134. A project workload refers to a workload for a given project that is desired to be completed. Client systems 134, as discussed above, may be any number of different systems that are connected to the server systems 104 through a network 102, such as client systems 108, 110 . . . 112 in FIG. 1A. The client systems 134 send results 132 back to the server systems 104 after the client systems 134 complete processing any given workload. Depending upon the workload project, the server systems 104 may then provide results 156 to customer systems 152. The customer systems 152 may be, for example, an entity that desires a given project to be undertaken, and if so, provides the project details and data 158 to the server systems 104.

It is noted, therefore, that the capabilities for client systems 108, 110 . . . 112 may span the entire range of possible computing, processing, storage and other subsystems or devices that are connected to a system connected to the network 102. For example, these subsystems or devices may include: central processing units (CPUs), digital signal processors (DSPs), graphics processing engines (GPEs), hard drives (HDs), memory (MEM), audio subsystems (ASs), communications subsystems (CSs), removable media types (RMs), and other accessories with potentially useful unused capabilities (OAs). In short, for any given computer system connected to a network 102, there exists a variety of capabilities that may be utilized by that system to accomplish its direct tasks. At any given time, however, only a fraction of these capabilities are typically used on the client systems 108, 110 . . . 112.

As indicated above, to encourage owners or users of client systems to allow their system capabilities to be utilized by control system 104, an incentive system may be utilized. This incentive system may be designed as desired. Incentives may be provided to the user or owner of the clients systems when the client system is signed-up to participate in the distributed processing system, when the client system completes a workload for the distributed processing system, or any other time during the process. In addition, incentives may be based upon the capabilities of the client systems, based upon a benchmark workload that provides a standardized assessment of the capabilities of the client systems, or based upon any other desired criteria.

Security subsystems and interfaces may also be included to provide for secure interactions between the various devices and systems of the distributed processing system 100. The security subsystems and interfaces operate to secure the communications and operations of the distributed processing system. This security subsystem and interface also represents a variety of potential security architectures, techniques and features that may be utilized. This security may provide, for example, authentication of devices when they send and receive transmissions, so that a sending device verifies the authenticity of the receiving device and/or the receiving device verifies the authenticity of the sending device. In addition, this security may provide for encryption of transmissions between the devices and systems of the distributed processing system. The security subsystems and interfaces may also be implemented in a variety of ways, including utilizing security subsystems within each device or security measures shared among multiple devices, so that security is provided for all interactions of the devices within the distributed processing system. In this way, for example, security measures may be set in place to make sure that no unauthorized entry is made into the programming or operations of any portion of the distributed processing system including the client agents.

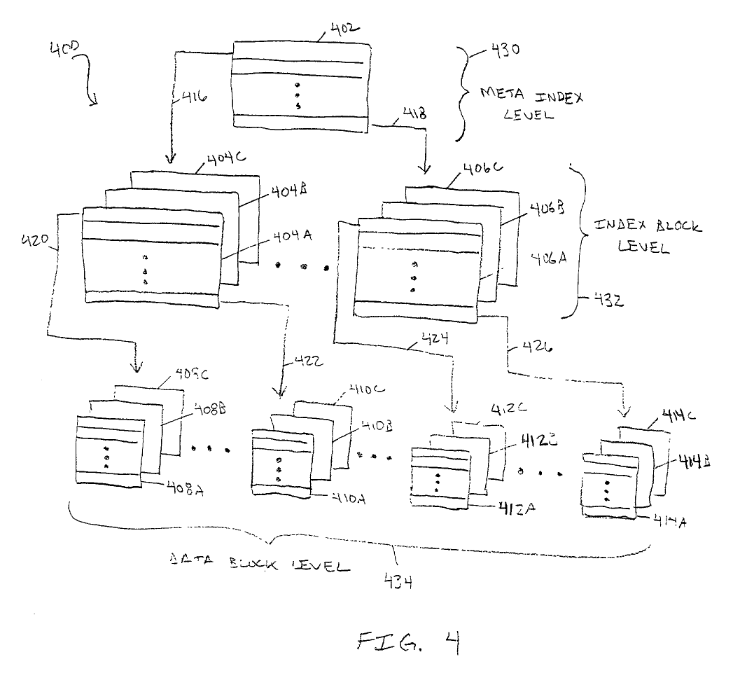

Now details of a massively distributed database (MDDB) system will be described with respect to FIG. 2, FIGS. 3A-3C and FIG. 4. In particular, FIG. 2 provides a block diagram for an example MDDB system. FIGS. 3A, 3B and 3C provide example block diagrams for coordinator computer, a worker computer and a user computer, respectively for the MDDB system. Finally, FIG. 4 provides a block diagram for an example database structure for a MDDB system.

It is noted that in the embodiment depicted, the MDDB system provides a relational database system, which is a system that provides the ability to create tables consisting of rows with fixed numbers and types of fields and that further provides the ability to look up, modify, and insert rows in tables, to perform select operations that return sets of rows satisfying a given criterion, and to perform join operations that combine rows from separate tables, according to given selection criteria and rules for combination. However, the organizational principles of MDDB system could also be used to provide a database system based on a hierarchical or entity/relationship data model, which represent other types of well known database structures. It is also noted that in one embodiment, MDDB system provides access to the database using the Structured Query Language (SQL), which is a well-known database query protocol. However, alternate implementations could use other access methods, if desired.

FIG. 2 is a block diagram for a MDDB system 200. In this embodiment, the MDDB system 200 includes server systems (coordinator computer systems) 104, customer systems (user computer systems) 152, and the client systems (worker computer systems) 134. The MDDB coordinator computer systems 104 can include a number of different computers CC₁, CC₂ . . . CC_{N} operating as coordinator computers 202. Coordinator computers 202 are those systems that manage and coordinate the operations of the MDDB and correlate to the server systems 104 in the distributed processing system 100. The MDDB worker computer systems 134 can include a number of different computers WC₁, WC₂. . . WC_{N} operating as worker computers 204. Worker computers 204 are those systems that are doing the work of storing and manipulating the data within the database and correlate to client systems 134 within the distributed processing system 100. The MDDB user computer systems 152 can include a number of different computers UC₁, UC₂. . . UC_{N} operating as user computers 206. User computers 206 are those systems that are using the database, for example, through search requests or data storage, and correlate to the customers systems 152 in the discussion of the distributed processing system 100 above. As with the distributed processing system 100, the MDDB system 200 includes network 102 through which the server systems 104, the client systems 134 and the customer systems 152 communicate with each other.

In one environment, it is contemplated that the coordinator computers (CC₁, CC₂. . . CC_{N}) 202 will be owned and operated by an entity that has overall management control of the distributed database system 200. It is also contemplated that the worker computers (WC₁, WC₂ . . . WC_{N}) 204 are computer systems that are not owned by this entity. Rather, the worker computers 204 are third-party owned network-connected computing devices running a MDDB software module. In addition, the user computers (UC₁, UC₂ . . . UC_{N}) 206 may be separate from the worker computers 204 and may be third-party owned network-connected devices requesting or desiring services from the MDDB system 200. It is noted that any given computer system could be a user computer 206, a worker computer 204 or a coordinator computer 202, or any combination of the three.

FIG. 3A is a block diagram for an example embodiment of a MDDB coordinator computer 202. A security/communication block 304 connects the MDDB coordinator computer 202 to the network 102, either directly or indirectly through other systems, through connection 312. As discussed above, a connection to the network 102 can taken any of a wide variety of forms that allows a computing device to communicate with other computing devices. A MDDB management program 302 operates on the MDDB coordinating computer 202 thereby providing the operational functionality desired for management and coordination of the MDDB system 200 or any desired portion thereof. The MDDB management program 302 communicates with and through the security/communication block 304. The local storage 306 holds information relevant to the operation of the MDDB management program 302 and the MDDB system 200. For example, this local storage 306 may store MDDB tables 308 and a worker database 310.

FIG. 3B is a block diagram for an example embodiment of a MDDB worker computer 204. A security/communication block 324 connects the MDDB worker computer 204 to the network 102, either directly or indirectly through other systems, through connection 326. As discussed above, a connection to the network 102 can taken any of a wide variety of forms that allows a computing device to communicate with other computing devices. A client agent 320 including a MDDB module 322 runs on the worker computer 204 to enable it to operate as part of the MDDB system 200. The MDDB module 322 communicates with and through the security/communication block 304. The local storage 328 holds information relevant to the operation of the MDDB module 322 and the MDDB system 200. For example, this local storage 328 may store MDDB data 330, including database contents, database index information or any other desired MDDB related information.

In one example embodiment for the MDDB system 200, the worker computers 204 can be made up of a significant fraction of all Internet-connected computers or devices. In this embodiment, the MDDB system 200 can be used by database applications, such as Web searching and content caching, whose requirements (in terms of storage, access rate, or both) are proportional to the size of the Internet as measured by computers, users, or Web pages. In an alternative embodiment, the MDDB system 200 can utilize computers within an organization as worker computers 204, and the MDDB system 200 can be used to support that organization's database applications.

FIG. 3C is a block diagram for an example embodiment of a MDDB user computer 206. A security/communication block 344 connects the MDDB user computer 206 to the network 102, either directly or indirectly through other systems, through connection 346. As discussed above, a connection to the network 102 can taken any of a wide variety of forms that allows a computing device to communicate with other computing devices. An MDDB application 340 including a MDDB user library 342 runs on the user computer 206 to enable it to use, search, write data to, request data from, and otherwise utilize the MDDB system 200. The MDDB application 340 communicates with and through the security/communication block 344. The local storage 348 holds information relevant to the operation of the MDDB application 340, the MDDB user library 342 and the MDDB system 200. For example, this local storage 348 may store a MDDB cache 350 that includes local data such as data blocks, index blocks, server address lists, or any other desired MDDB related information.

Looking to FIGS. 2 and 3A-C together, one example MDDB system 200 configuration will now be described. First, a relatively small number of the coordinator computers 202 can be utilized, for example, from one to a few hundred. In this example, these coordinator computers 202 are owned and controlled by the organization(s) administering the database or the MDDB software, or both. As described above, the coordinator computers 202 are connected to a communication network 102, such as the Internet, and are accessible except for periods of maintenance and hardware or software failures. With respect to worker computers 204 for this example MDDB system 200, several thousand to several million or more are utilized. Worker computers 204 may be, for example, home personal computers (PCs), desktop computers, workstations or any other connected processing devices, as discussed above. The worker computers 204 may be intermittently inaccessible, due to being turned off or disconnected from the network. The worker computers 204 may be owned and controlled by individuals or by organizations other than those administering the database or the MDDB software. In addition, the owner of each worker computer 204 can be allowed to limit the amount of disk storage, memory, communication bandwidth and/or other resource used by that computer for MDDB functions.

With respect to database functions, it is noted that each worker computer 204 can act as a database user, a database server, or both. As a database server, a worker computer 204 may provide storage for data, indexing information, and/or any other desired database functionality. As stated above, the worker computers 204 execute a MDDB module 322 that handles these desired functions. Because each worker computer 204 is expected to be used by its owner or operator for the personal or business purposes of that owner or operator, the MDDB module 322 is preferably designed not to interfere with the normal operational functions of the worker computer 204. Depending on the system, the MDDB module 322, for example, might run as a low-priority process or as a screensaver-type program that runs only when there is no user activity. Similarly, the MDDB module 322 might act as a low-priority user of disk space. The MDDB module would use a fixed fraction (say 90%) of the otherwise free disk space on the system. When the amount of free space (excluding the part used by MDDB) falls below a predetermined limit, MDDB would free disk space until the limit is again exceeded.

Once the coordinator computers 202 and the worker computers 204 are operating to provide the MDDB system 200, any number of user computers 206 may utilize this MDDB system 200. The user computers 206 are those computers or devices from which database queries are issued or initiated. Thus, they run MDDB application software 340 that can issue these queries and an MDDB user library 342 that handles the queries. It is noted that any number of applications may be run on a user computer 206 to issue such queries and that the set of user computers 206 may overlap partly or entirely with the set of worker computers 204 and coordinator computers 202, as desired.

FIG. 4 is a block diagram for an example database structure 400 for the MDDB system 200. This example illustrated the organization of one database table; in practice there would be many such tables. In the embodiment depicted, there are three basic database levels: meta-index level 430, index block level 432, and data block level 434. The meta-index level 430 includes at least one meta-index table 402 that holds a plurality of blocks of meta-index information identifying the underlying index block tables 404 . . . 406 in the index block level 432. The lines 416 and 418 represent blocks of meta-index information that identify index block tables 404 and 406, respectively. As depicted, the index block tables 404 . . . 406 within the index block level 432 are replicated, such that index block tables 404A, 404B and 404C contain duplicate sets of information, as do index block tables 406A, 406B and 406C. The index blocks 404 . . . 406 hold a plurality of blocks of index information identifying the underlying data block tables 408 . . . 410 . . . 412 . . . 414 in the data block level 434. The lines 420, 422, 424 and 426 represent blocks of index information that identify data block tables 408, 410, 412 and 414, respectively. As depicted, the data block tables 408 . . . 410 . . . 412 . . . 414 within the data block level 434 are replicated, such that data block tables 408A, 408B and 480C contain duplicate sets of information, as do data block tables 410A, 410B and 410C, data block tables 412A, 412B and 412C, and data block tables 414A, 414B and 414C. The data block tables 408 . . . 410 . . . 412 . . . 414 hold a plurality of blocks of data information representing the contents of the database for the MDDB system 200. By breaking the database upon into these various levels, the MDDB system allows for the distribution of database storage and functions across a large number of connected devices.

Using this example database structure 400, the MDDB system 200 can distribute data across the worker computers 204 and each block of data can be replicated on many different worker computers 204 to increase throughput and availability. Similarly, the indexing information in the index block level 432 can be used to locate a replica of a given data unit and is also distributed and replicated on worker computers 204. Coordinator computers are used to store a master copy of the top-level indexing information in the meta-index level 430. In this architecture for the MDDB system 200, most data accesses (e.g., looking up a data item with a given index value) can be handled entirely by worker computers 204. Therefore, the storage capacity (maximum database size) and performance capacity (maximum number of accesses per second) of the database increase in direct proportion to the number of worker computers 204. In addition, the MDDB system 200 can allow the MDDB applications 340 to specify their semantic requirements. For example, to maximize performance, MDDB applications 340 can specify relaxed semantics, such as specifying “eventual consistency” in which database updates, insertions and deletions are visible not immediately but in a bounded amount of time.

The MDDB database architecture 400 includes one or more data block tables 408A-C . . . 410A-C . . . 412A-C . . . 414A-C. Each of these tables includes of a number of records, each of which consists of a fixed number of fields. One or more of these fields may be designed as key fields. The MDDB database architecture 400 also maintains indices in tables 404A-C . . . 406A-C, allowing queries that reference these key fields to be performed efficiently. For simplicity, in the remainder of this description we will assume that each of the tables 408A-C . . . 410A-C . . . 412A-C . . . 414A-C has a single key field, so that there is only one index. However, it is noted that in its most general form the invention allows for multiple key fields, as desired.

A given data block table 408A-C . . . 410A-C . . . 412A-C . . . 414A-C is divided into a number of data blocks. Each block consists of a set of records whose key values form a contiguous range in the table. The size of a data block is determined by the MDDB system 200 to optimize performance. An excessively large block size reduces the degree of parallelism with which database operations, such as “Select” and “Join” operations, can be done. An excessively small block size imposes higher communication overhead and index size. Data can be stored, for example, in an encrypted form on local disk storage, so that a malicious user on a worker machine cannot view data.

Preferably, each data block is stored in many identical replicas on worker computers 204. The number of replicas may be large (e.g., hundreds or thousands). The decision of how many replicas to use, and where to put them, is made in such a way as to satisfy the availability and performance requirements of the database application. For example, suppose certain worker computers (e.g., home computers) are found to be available 50% of the time. Putting a single replica on such a computer would give 50% availability. However, using ten replicas would provide 99.9% availability, assuming independence of downtime.

To manage these replicas, the replicas of a particular block can be classified as “read-only” or “read/write.” Preferably, there will be an odd number of read/write copies, and a write operation must successfully modify a majority of them. The choice of how many read/write replicas to use, and where to locate them, is made so as to satisfy availability and performance requirements. Using more read/write replicas generally increases availability but decreases performance.

The MDDB database architecture 400 may also take advantage of any desired index organization scheme. For example, an index in a table can be divided into a number of index block tables 404A-C . . . 406A-C. Each of these index block tables include index blocks that describe a range of data blocks with contiguous key field values. For each data block, the index block contains, for example: (1) its key range, (2) a list of data servers containing replicas of the data block, (3) information about each server, such as its speed and location, and (4) any other desired information. As with data, this index information can also be encrypted, so that a malicious user on a worker machine cannot see other worker addresses or key values. In addition, each worker storing an index block can maintain a load-balancing vector indicating for each replica of a data block what percentage of requests should be directed to that worker. As with data blocks, the index block size can be determined by MDDB system 200 to optimize performance. Also, each index block can be stored in many identical replicas on worker computers with these index blocks being divided into read-only and read/write replicas.

The meta-index table 402 includes a list of index block tables. Each index block may contain, for example: (1) its range of key values, (2) the list of index servers storing it, and (3) any other desired information. The meta-index of a table is stored in the meta-database and, in partial form, in MDDB caches 350 on the user computers 206.

The coordinator computers 202 use the meta-database to maintain information about worker computers 204, the MDDB index tables, and the assignment of data to workers.

Specifically, the meta-database may contain, for example:

(1) a list of all worker computers 204, and for each worker computer 204:

(a) total disk space and percentage free,

(b) total bandwidth and percentage free,

(c) availability (a statistical summary of the periods during which the computer is on and connected to the network), and

(d) any other desired information; and

(2) a list of MDDB index tables and for each table:

(a) read rate,

(b) write rate,

(c) required availability,

(d) required response time,

(e) the meta-index, and

(f) any other desired information.

In operation, coordinator computers 202 store a load-balancing vector for the index servers for a given table, indicating what fraction of requests should be directed to each server. The meta-database can be implemented using MDDB system 200 itself, or may be implemented using a conventional commercial relational database system. The coordinator computers can perform a variety of functions, including the following functions: (1) handle initial requests from clients (thereafter, most requests are handled by worker computers), (2) handle requests to create and delete tables, (3) decide on the data and index block sizes, and (4) decide where to locate data and index page replicas, both initially (when the pages are created) and in response to changing load conditions.

The MDDB user library 342 on each user computer 206 can store a variety of information. For example, the following information may be stored: (1) the address of one or more coordinator computers, (2) a partially-populated meta-index of recently used tables (i.e., key ranges of some index blocks and one or more index server addresses), and (3) for each recently used data block, one or more data server addresses, and possibly the block itself. This information may be stored on disk in the MDDB cache 350 with recently used items being stored in the memory.

In addition, the MDDB system 200 may utilize a variety of communication mechanisms, as desired. For example, one MDDB system function can be a multicast mechanism that allows a computer within the MDDB system 200 to efficiently send a message to a large number of recipients. This function may be provided by the network infrastructure, if not implemented by MDDB system itself, using any of the widely-known multicast protocols, such as protocols discussed in S. Deering and D. Cheriton, “Multicast Routing in Datagram Internetworks and Extended LANs,” ACM Transactions on Computer Systems (TOCS), Vol. 8, No. 2, pp 85-110, May, 1990. The MDDB system 200 can also utilize a variety of data models and organizations, as desired. For example, the MDDB system 200 can support a relational database model, such as disclosed in E. F. Codd, “A Relational Model of Data for Large Shared Data Banks,” Communications of the ACM 13(6), pp. 377-387, (1970).

The MDDB system 200 may also allow for any of a variety of database operations, including, for example, Table Creation/Deletion operations, Lookup operations, Select operations, Join operations and Insert/Delete/Update operations, as discussed further below.

The Table Creation/Deletion operation may be issued to a coordinator computer, which then decides on the data and index block sizes and records the table in the meta-database.

The Lookup operation looks up the record with a given key value and may be done in the following steps:

(1) If have data in user cache, get record from there.

(2) If have server address for the data, get copy of data block from the server. If not, contact index server to get list of data servers.

(3) If the data server is not reachable, try next server in list.

(4) If get “stale server” message from data server, or reach end of data server list, contact index server to get new list of data servers.

(5) If not reachable, try next index server.

(6) If get “stale server” message from index server, or reach end of index server list, contact coordinator to get new list of index servers.

The Select operation returns all the records whose key values satisfy a given criterion and may be done in the following steps:

(1) Get the key range for each index block in the table, either from cache or by contacting a coordinator computer.

(2) For each data block whose key range is compatible with the criterion, obtain the address of at least one data server. This may require querying an index server.

(3) Send the select request to a data server for each of these data blocks. These servers will process the select request, and return the set of rows satisfying the criterion. These requests, and the handling of the replies, are done in parallel.

(4) If one or more data servers fails to respond within a timeout period, send the request to another replica of that page.

(5) Repeat the above step until the all pages have been handled and collate and return the results.

By parallelizing this select query over a large number of data servers, significant processing speed improvements can also be achieved.

The Join operation returns combined records from two tables for which the key values are equal. This Join operation may be implemented, for example, as follows:

(1) As with the Select operation, get at least one data server address for each block.

(2) Select one replica of each data block from each table.

(3) Choose one table, say table A, as the “master” for the join. This choice could be made randomly, for example, or on the basis of information about the distribution of key values.

(4) Send a “join” message to each data server for table A. This message instructs the data server to contact appropriate server(s) for the other replicated tables, to find rows that match the join criteria, to merge and sort the results, and to return the results.

(5) If one or more data servers fails to respond within a timeout period, send the request to another replica of that page.

(6) Repeat the above step until the all pages have been handled. Collate and return the results.

As with the Select operation, the Join operation query may be parallelized over a large number of data servers to improve processing efficiency.

Insert/Delete and Update operations introduce new data, modify data, or remove data from the database. These operations can be done as follows:

(1) Contact a read/write replica of the data block for this key.

(2) That server multicasts the change to other replicas.

(3A) Insert—If block exceeds block size, split the block. Contact coordinator to get list of new data servers. Update other master copies. Send partial pages to new data servers. Update the corresponding index block.

(3B) Delete—If page is too small, rebalance with adjoining pages, possibly deleting this page. Update index block copies.

It is noted that index blocks may be updated similarly to data blocks, with the coordinator servers taking the place of index block servers.

To provide additional operational efficiency, the MDDB system 200 can also utilize hierarchical dynamic load balancing, in addition to the capabilities balancing discussed above with respect to FIGS. 1A and 1B, to maintain good overall performance in either of these cases. The rate of access to the various tables in an instance of the invention may vary over time. Furthermore, some of the worker machines assigned to a given table may cease to function or may be loaded by higher-priority tasks. Viewing an instance MDDB system as a tree, this hierarchical dynamic load balancing mechanism balances the load first among the leaves on a branch, then among branches and so on.

More specifically, for example, the following procedures may be utilized for data servers and index servers, respectively. First, data servers periodically report their performance (average latency) to an index server. If there is a large discrepancy between performance on different replicas of a given page, the index server computes a new load-balancing vector and distributes it to the other replicas of the index block. In extreme cases, it may broadcast a message to data servers telling them to return “stale server” responses to client queries, so that clients will be redirected quickly to new data servers. If there is a large discrepancy between performance across different pages within the index block, the index server reassigns pages, creating additional replicas of pages having worse performance. Similarly, index servers periodically report their performance, and the aggregate performance of their data servers, to a coordinator. If there is a large discrepancy between performance on replicas of a given index page, the coordinator computes a new load-balancing vector and distributes it to other coordinators. If there is a large index performance discrepancy among the index pages of a table, or between tables, the coordinator reassigns index pages. If there is a large data performance discrepancy, the coordinator reassigns data page replicas.

The coordinator computers periodically check the availability of each worker computer, either by contacting it directly or by delegating this check to another worker computer. If a worker computer is unavailable for a period exceeding a certain threshold, indicating that the computer has failed or has been disconnected from the network, then the index and data blocks stored on that computer are reassigned to other worker computers.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures for database processing. For example, equivalent elements may be substituted for those illustrated and described herein, and certain features of the invention may be utilized independently of the use of other features, all as would be apparent to one skilled in the art after having the benefit of this description of the invention.

What is claimed is:

1. A distributed database system, comprising:
a plurality of distributed worker systems, the worker systems acting as data servers;
at least one coordinator system configured to communicate with the plurality of worker systems through a network; and
a database administered by a first entity utilizing the coordinator system and the plurality of worker systems, wherein at least a portion of the plurality of worker systems are owned and operated by at least one second entity that is different from the first entity.

2. The distributed database system of claim 1, wherein the plurality of worker systems comprise over a thousand systems.

3. The distributed database system of claim 1, wherein the coordinator system maintains information about the current performance and availability of each of the worker systems.

4. The distributed database system of claim 1, wherein operators of each worker computer can control parameters of data server usage for the worker computer.

5. The distributed database system of claim 4, wherein the controlling parameters comprise an amount of network bandwidth utilized, disk space usage, or hours of usage.

6. The distributed database system of claim 1, wherein data and indexing information for the database is organized in a multi-level hierarchy.

7. The distributed database system of claim 6, wherein distribution of data, index information, and user requests are dynamically modified in response to an actual load to optimize performance of the database system.

8. A distributed database system, comprising:
at least one thousand distributed worker systems, the worker systems acting as data servers;
at least one coordinator system configured to communicate with the worker systems through a network; and
a database administered by utilizing the at least one coordinator system and the plurality of worker systems.

9. The distributed database system of claim 8, wherein the database is administered by an entity and the worker systems are owned and operated by the same entity.

10. The distributed database system of claim 8, wherein the network comprises the Internet.

11. A distributed processing system providing database operations, comprising:
a plurality of client systems running a client agent program, the client agent program comprising a database module;
at least one server system configured to communicate with the plurality of client systems through a network to coordinate database workloads processed by the database modules; and
a capabilities database coupled to the server system, the capabilities database comprising data concerning processing capabilities for the client systems;
wherein the server system utilizes the capabilities database to schedule database workloads for the database modules.

12. The distributed processing system of claim 11, further comprising a system load database comprising load data about each client system, the load data identifying current database workload processing utilization for the client system.

13. The distributed processing system of claim 12, wherein the server system utilizes the current load data to balance database workloads among the client systems.

14. The distributed processing system of claim 11, further comprising an incentives database coupled to the server system, the incentives database comprising incentive data for each of the client systems, the incentive data acting to encourage each client system to be utilized for objectives of the distributed processing system.

15. The distributed processing system of claim 14, wherein the incentive data comprises sweepstakes entries for database tasks accomplished by each client system.

16. The distributed processing system of claim 11, wherein the network comprises the Internet.

17. A method of operating a distributed database system, comprising:
coupling a coordinator system to a network, the coordinator system configured to communicate with a plurality of worker systems through a network, and the worker systems acting as data servers for a database system; and
administering the database system through a first entity that does not own or operate all of the worker systems.

18. The method of claim 17, wherein the plurality of worker systems comprises over a thousand systems.

19. The method of claim 17, further comprising allowing operators of each worker system to control parameters of data server usage for the worker system.

20. The method of claim 19, wherein the controlling parameters comprise an amount of network bandwidth utilized or hours of usage.

21. The method of claim 17, further comprising organizing data and indexing information for the database in a multi-level hierarchy.

22. The method of claim 21, further comprising dynamically modifying distribution of data, index information, and user requests in response to an actual load to optimize performance of the database system.

23. The method of claim 18, wherein the network comprises the Internet.

24. A method of operating a distributed processing system to provide a distributed database system, comprising:
coupling at least one coordinator system to a network, the coordinator system configured to communicate with a plurality of worker systems through a network, the worker systems acting as data servers for a database system and comprising at least one thousand worker systems; and
administering the database system utilizing the coordinator system and the worker systems.

25. The method of claim 24, wherein the database is administered by an entity and the worker systems are operated by the same entity.

26. A method of operating a distributed processing system to provide a distributed database system, comprising:
coupling a server system to a network, the server system being configured to communicate with a plurality of client systems through a network, the client systems configured to run a client agent program, and the client agent program running a database module that allows the client systems to function as data servers for a distributed database system;
storing in a capabilities database data concerning processing capabilities for the client systems; and
managing the distributed database system with the server system utilizing the capabilities database to schedule database workloads for the database modules.

27. The method of claim 26, further comprising storing in a system load database load data about each client system, the load data identifying current workload processing utilization for the client system.

28. The method of claim 27, further comprising utilizing the current load data to balance database workloads among the client systems.

29. The method of claim 26, further comprising storing in an incentives database incentive data for each of the client systems, the incentive data acting to encourage each client system to be utilized for objectives of the distributed processing system.

30. The method of claim 29, wherein the incentive data comprises sweepstakes entries for database tasks accomplished by each client system.

31. The method of claim 26, wherein the network comprises the Internet.
